(19) United States
(12) Patent Application Publication
(10) Pub. No.: US 2018/0036640 A1
(43) Pub. Date: Feb. 8, 2018

(54) Augmented Reality System

(71) Applicants: Noble A. Drakoln, Cowan Heights, CA (US); Paul Jesus Limon, Cowan Heights, CA (US)

(72) Inventors: Noble A. Drakoln, Cowan Heights, CA (US); Paul Jesus Limon, Cowan Heights, CA (US)

(73) Assignee: Battleshirts, Cowan Heights, CA (US)

(21) Appl. No.: 15/668,613

(22) Filed: Aug. 3, 2017

Related U.S. Application Data
(60) Provisional application No. 62/370,677, filed on Aug. 3, 2016.

(51) Int. Cl. A63F 13/65; A63F 13/53; G06K 9/00; A63F 13/25; G06T 11/60; G06T 19/00

(52) U.S. Cl. CPC A63F 13/65; G06T 11/60; G06T 19/006; G06K 9/00671; A63F 13/25; A63F 13/53

(57) ABSTRACT

An enhanced augmented reality system and method comprising a smart device, a camera, a processor, a storage and a physical object comprising one or more than one text, image or pattern on the physical object, where the text, image, or pattern on the object is associated with instructions executable on a processor for displaying augmented reality to a user. There is also a method useful for the system comprising the steps of a) locating a text, image or pattern using a smart device; b) scanning the text, image or pattern using a camera embedded in the smart device; c) retrieving and executing instructions executable on a processor from a storage to start enhanced augmented reality associated with the text, image or pattern; and d) repeating steps a-c until a predefined goal has been reached by the user or the instructions executed by the processor associated with the object have completed.

### CROSS-REFERENCE TO RELATED APPLICATIONS

This Application claims the benefit under 35 U.S.C. § 119(e) of U.S. Provisional Patent Application Ser. No. 62/370,677, filed on Aug. 3, 2016, the contents of which are incorporated herein by reference in their entirety.

### FIELD OF THE INVENTION

The present invention relates to augmented reality systems, and more specifically to an enhanced augmented reality system.

### BACKGROUND

There are many examples of augmented reality systems, such as, for example, Pokemon Go® that uses a location-based augmented reality for players to find Pokemon. However, the system is limited in that the objects to be found in the game are all virtual. There are no physical objects to be found or used in the game. Augmented reality applications enhance object by displaying information overlays and digital content tied to physical object locations. However, these objects are static and unmovable.

Therefore, there is a need for an enhanced augmented reality system that can provide additional entertainment or information from multiple physical objects for single or multiple users simultaneously.

### SUMMARY

The present invention overcomes the limitations of the prior art by providing a system for augmented realty that comprises a smart device with a camera, a processor , a storage and a physical object comprising one or more than one text, image or pattern disposed on the physical object communicatively coupled to the smart device. The text, image, or pattern is associated with instructions executable on the processor disposed in the smart device for displaying augmented reality to a user.

The instructions executable on the processor comprise first, acquiring an image of the physical object with the one or more than one text, image, or pattern. Then, determining if the one or more than one text, image, or pattern is associated with instructions for augmented reality. Finally, retrieving and executing on the processor the instructions associated with the object, without relying on the objects geolocation. The the instructions associated with the object are selected from the group consisting of an animation, a 2D character, a 3D character, an interactive experience, and a game among others and. The instructions associated with the object are also communicatively linked to a plurality of users simultaneously. This enables multiple users to experience the same game, entertainment, information, interactivity or educational content. For game play, the instructions associated with the object provide the plurality of users with a score, a task and/or a goal for a competition. The shared instructions associated with the object can also provide coordination between the plurality of users. This can assist multiple players to stay on the agreed goal or task while not being physically located next to one another. To enhance the experience, the instructions associated with the object can display costume and garb associated with a character represented by the physical object. The costume and garb are overlaid on the player when viewed through the smart device to add realism.

The instructions associated with the object can also display information related to the physical object and can overlay it on the physical object when viewed through the smart device to add meaning to the object. For example, looking at a family photobook, information about how the people in the photograph are related to the viewer and each other can be displayed. This can preserve familial history and share memories of past relations with the current generation. Alternatively, in game play, a physical object, such as, for example, a sword, can have special properties only visible to the user holding the sword, but can be shown to other players. Also, if a user obtains an object that changes the character's capabilities or role (ie. good to evil), the instruction associated with the object adjust the user's outer appearance and capabilities automatically.

There is also provided a method for augmented realty comprising the steps of first, locating a text, image or pattern using a smart device. Then, scanning the text, image or pattern using a camera embedded in the smart device. Next, retrieving and executing instructions executable on a processor from a storage to start enhanced augmented reality associated with the text, image or pattern. Then, requesting additional actions by the user and stored in a storage. Next, uploading information to the smart device by a user. Then, scanning the text, image or pattern and retrieving multimedia information related to the text, image or pattern that is displayed to the user. Finally, repeating these steps until a predefined goal has been reached by the user, the instructions executed by the processor associated with the object have completed, or both a predefined goal has been reached by the user and the instructions executed by the processor associated with the object have completed.

### BRIEF DESCRIPTION OF THE DRAWINGS

FIG. 1 is a prior art representation of current augmented reality system;

FIG. 2 is a diagram of apparel with an image, a pattern or both an image and a pattern on the apparel;

FIG. 3 is a diagram of the enhanced augmented reality system used for a single user;

FIG. 4 is a diagram of an enhanced augmented reality system that can provide additional entertainment or information from multiple physical objects for single or multiple users simultaneously;

FIG. 5 is a diagram of a physical object with an image, text or both an image and text useful for the enhanced augmented reality system of FIG. 1; and

FIG. 6 is a flowchart diagram of some steps of a method for using the enhanced augmented reality system of FIG. 1.

### DETAILED DESCRIPTION OF THE INVENTION

The present invention overcomes the limitations of the prior art by providing an enhanced augmented reality system that can provide additional entertainment or information from multiple physical objects for single or multiple users simultaneously. Typical game play today is interactive using multiple players. Current augmented reality systems do not allow for interactions between players or objects that can be changed. For example, in the Pokemon Go® game, a single use finds a virtual Pokemon at a specific location, then, once the use has reached that location, the virtual Pokemon can be claimed by the user. However, the entire rest of the game, and all other interactions, then occur virtually. The present invention allows for the users to change the gameplay and interact with each other in a novel manner that has not been available before.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Systems, methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code that can comprise one or more executable instructions for implementing the specified logical function(s). It should also be noted that, in some alternative implementations, the functions noted in the blocks can occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “server” refers to one or more than one device with at least one processor configured to transmit, receive and store: instructions executable on the at least one processor; and data from either a local or remote computing device. In some instances, the local computing device can also be the server.

The term “smart device” refers to any device that comprises hardware capable of presenting augmented reality to a user.

Various embodiments provide an enhanced augmented reality system that can provide additional entertainment or information from multiple physical objects for single or multiple users simultaneously. One embodiment of the present invention provides a wearable device an enhanced augmented reality system that can provide additional entertainment or information from multiple physical objects for single or multiple users simultaneously. In another embodiment, there is provided a method for using the system. The system, device and method will now be disclosed in detail.

Referring now to FIG. 1, there is shown a prior art representation 100 of a current augmented reality system. The present invention can use the smartphone, tablets and specialty devices, such as, for example, Google Glass®, to execute the augmented reality application related to the enhanced object used.

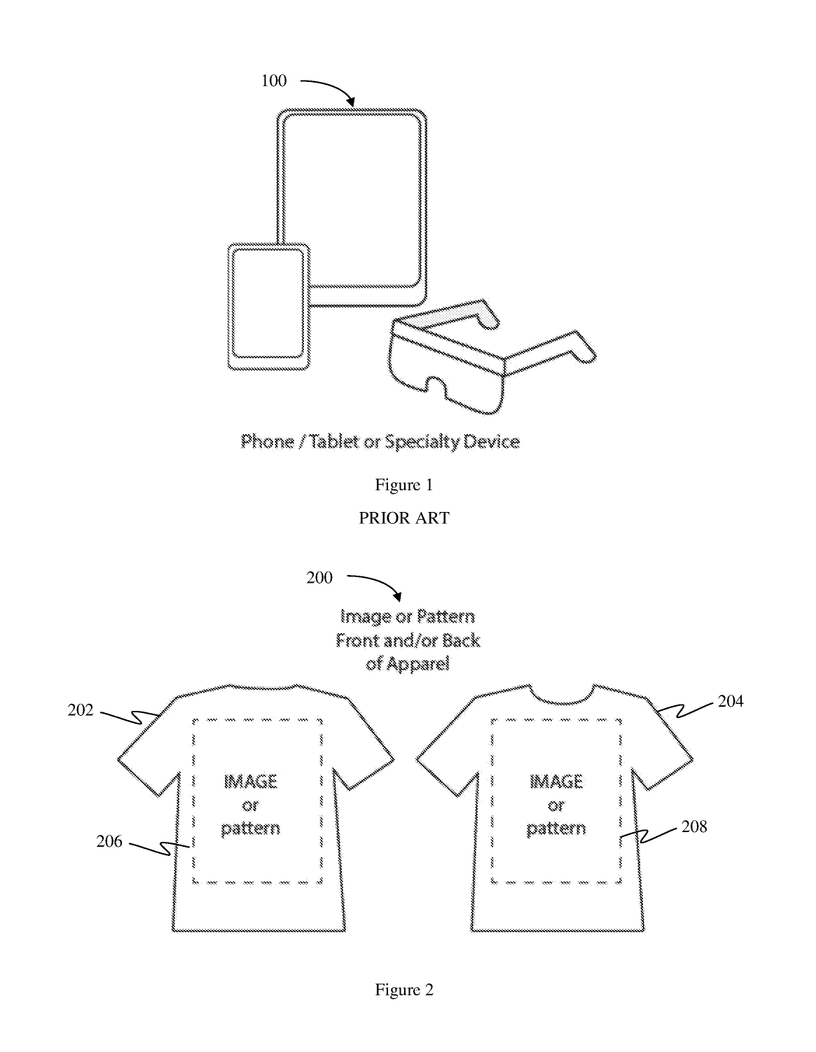

Referring now to FIG. 2, there is shown a diagram 200 of apparel 202 and 204 with one or more than one image, one or more than one pattern or both one or more than one image and one or more than one pattern 206 and 208 on the apparel 202 and 204. Using the enhanced augmented reality system, a wearable text/image/pattern 206 and 208 can be used to perform a variety of functions. For example, in this embodiment, the shirts 202 and 204 are used as part of a game. Players can wear their identifiable shirts 202 and 204 as part of a larger playing ecosystem. This also gives the players the opportunity to alter their player identification and affiliations.

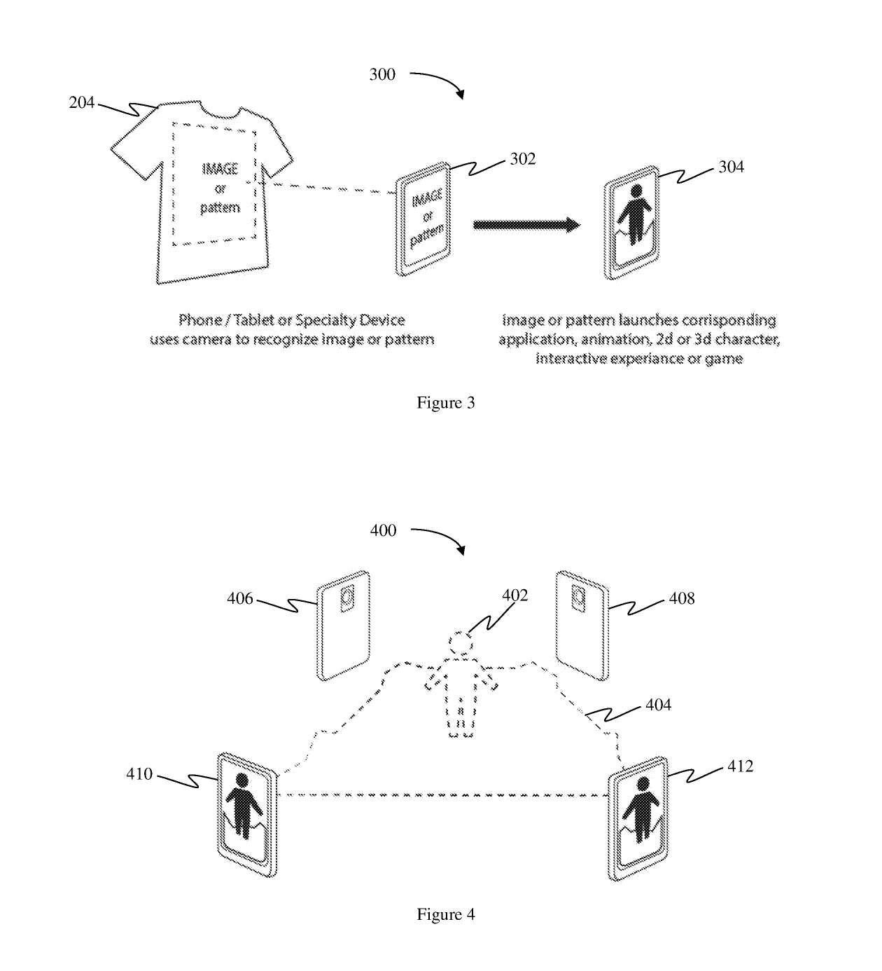

Referring now to FIG. 3, there is shown a diagram of the enhanced augmented reality system 300 used for a single user. The system 300 uses a processor and a camera of a smart device 304 to image and process one or more than one text, image, or pattern 302. Once the text/image/pattern 302 has been captured, the smart device 302 executes instructions executable on a processor to decipher and determine if the text/image/pattern 302 is an augmented reality object. Then, the system then executes instructions executable on a processor associated with the one or more than one text, image, or pattern 302 on the object, without relying on the objects geolocation. The text/image/pattern 302 can launch application, an animation, a 2D character, a 3D character, an interactive experience, or a game. This location free aspect of the system 300 provides for more, and different, capabilities than is currently available with non-enhanced augmented reality or location based augmented reality that can limit current systems.

Referring now to FIG. 4, there is shown a diagram of an enhanced augmented reality system 400 that can provide additional entertainment or information from multiple physical objects 402 and 404 for a plurality of users 406, 408, 410 and 412 simultaneously. As can be seen, the plurality of users 406, 408, 410 and 412 can interact with another user 402 wearing an enhanced augmented reality object, and can compete with each other depending upon the goals of the game or the object of a task. The present system 400 is not limited to just games, but can be used in education and work related activities that require coordination among multiple users 406, 408, 410 and 412 to accomplish a task or goal. For example, a first electrician troubleshooting wiring a building can be directed to the correct location in a particular part of the structure using text and/or images affixed to the area. In another part of the structure a second electrician can locate and be in contact with the first electrician so that they can coordinate the troubleshooting. Additionally, safety instructions can be presented to the first and second electricians prior to working on any of the wiring to insure safety protocols are presented and any unintended consequences for certain action, like turning off the main breaker. As will be understood by those will skill in the art with reference to this disclosure, the educational uses of the system are nearly infinite and only limited by the imagination of the person creating the enhanced text/image/pattern 206 and 208 for use in the system.

In another example, a game of Dungeons and Dragons® can be changed from a group of players sitting is a room together, to an interactive game that can be played anywhere in the world. For instance, if a new player wanted to join a game in progress, they would don the appropriate “Battle shirt” with the appropriate text/image/pattern 206 and 208 that would identify the new player's character and the character's abilities. The new player could then use their smart device comprising the enhanced augmented reality system 400 to locate a game in progress. Using the enhanced augmented reality system 400, the new play can approach other players 406, 408, 410 and 412 that are also either looking for a game to play or engaged in play and seeking additional players. The other players 406, 408, 410 and 412 can scan the new player's battle shirt comprising the text/image/pattern 206 and 208, that will load the new player's character information into the system 400 and then the new player can join the current quest. Additionally, different groups of players 406, 408, 410 and 412 can identify a single goal and compete with each other to see which team completes the quest first. The was not previously possible.

Game play can also be enhanced using the system by displaying the costume and garb normally associated with a character overlaid on the player to add realism to the game play. Additionally, a shared experience between smart devices, with common goals and interactive elements 404 can be shown to each of the players Also, players in some games switch side, such as, for example, changing from good to evil, etc. The system 400 can adjust the player's outer appearance and capabilities automatically, depending upon the instructions executed.

In yet another example, an unconscious patient transported to a hospital can have a physical object placed on them to identify a variety of issues or procedures that have been done to the patient. The information associated with the physical object can be updated for the plurality of users. This can prevent many procedural errors during treatment. For example, if the patient requires surgery, a physical object can be placed on the patient listing blood type, allergies, or other problems that could affect the procedure. Additional information can be displayed to the surgeon, nurses, anesthesiologist, or other personnel working on the patient. A coordinated effort is share amongst the plurality of users, thereby saving time and effort.

As can be appreciated, the expansive capabilities of the system 400 can take a traditional board game, such as Monopoly® and turn it into a real life adventure with people vying for position and locations in the shared experience 404 while being able to identify other players that they may never have met previously.

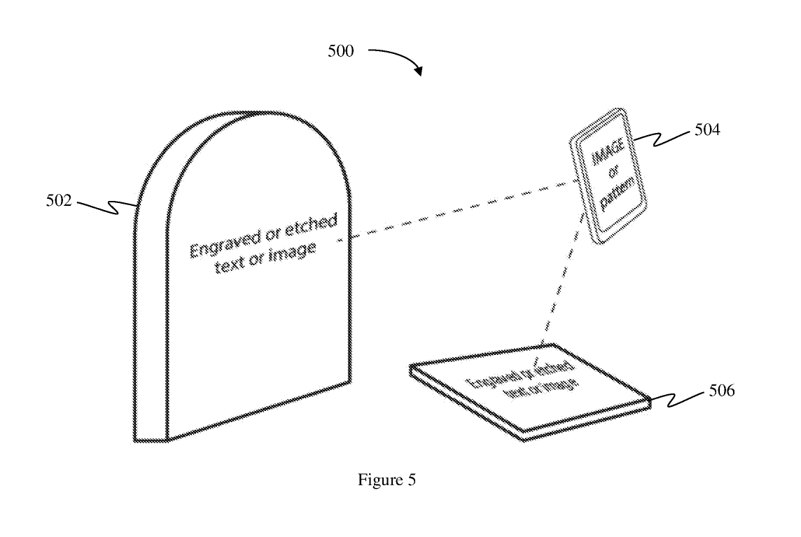

Referring now to FIG. 5, there is shown a diagram 500 of a physical object 502 and 506 with a augmented reality text/image/pattern 504 embedded or placed on the physical object 502 and 506 that is useful for the enhanced augmented reality system of FIG. 1. Alternatively, static objects can be used with the enhanced augmented reality system 400 to produce lasting memories. For example, a tombstone, urn or marker 506 can be scanned by a user's smart device and personal history, family photos, video, recording and other memorabilia can be displayed to the user or to one or more than one family member. The information can be updated, or attached to genealogical information or other data that may be helpful to families or researchers if permitted. Other resting places for relatives can be shown and the visiting relatives can be lead to other family members to discover their own past and the stories and information related to each person. Because the text/image/pattern 206 and 208 can be affixed at any time, entire family histories can be updated and shown at any time.

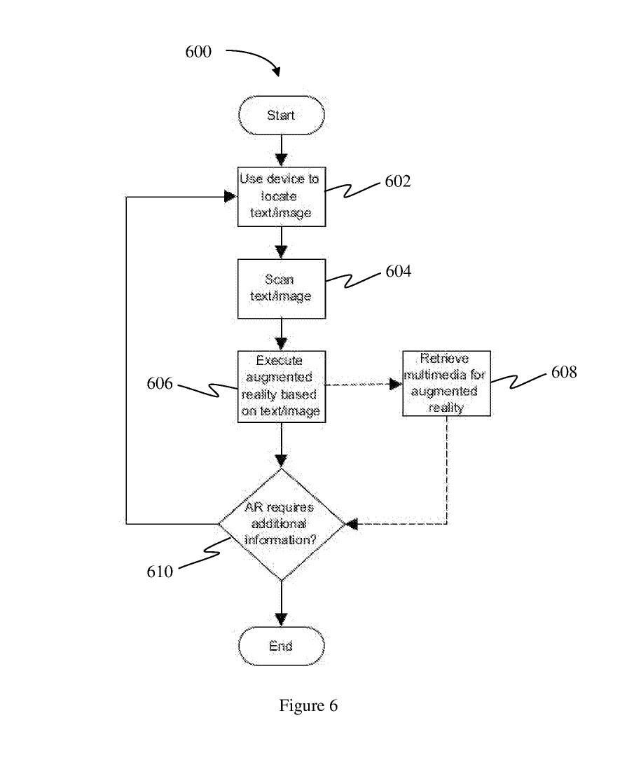

Referring now to FIG. 6, there is shown a flowchart diagram 600 of some steps of a method for using the enhanced augmented reality system of FIG. 1. First, a smart device is used to locate where a text, image or pattern is located. Optionally, a user uploads the information to the smart device. Then, the text, image or pattern is scanned by a camera embedded in the smart device. Next, the smart device retrieves and executes instructions executable on a processor from a storage to start enhanced augmented reality associated with the text, image or pattern. Optionally, scanning the text, image or pattern will retrieve multimedia information related to the text, image or pattern for use by the enhanced augmented reality system 400. If the augmented reality requires additional actions by the user, instructions are retrieved and executed on the processor and the additional actions can be performed and stored in a storage by the system 400. Finally, the steps are repeated until a goal has been reached by the user or the end of the instructions executed by the processor of the enhanced augmented reality system 400 has been reached.

What has been described is a new and improved system for an enhanced augmented reality system that can provide additional entertainment or information from multiple physical objects for single or multiple users simultaneously, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A system for augmented realty, the system comprising:
a. a smart device;
b. a camera connected to the smart device;
c. a processor connected to the smart device;
d. a storage connected to the smart device; and
e. a physical object comprising one or more than one text, one or more than one image or one or more than one pattern on the physical object communicatively coupled to the smart device, where the one or more than one text, image, or pattern is associated with instructions executable on the processor in the smart device for displaying augmented reality to a user.

2. The system of claim 1, where the smart device comprises instructions executable on the processor for:
a. acquiring an image of the physical object comprising one or more than one text, image, or pattern;
b. determining if the one or more than one text, image, or pattern is associated with instructions for augmented reality;
c. retrieving and executing on the processor the instructions associated with the object, without relying on the objects geolocation;

3. The system of claim 2, where the instructions associated with the object are selected from the group consisting of an animation, a 2D character, a 3D character, an interactive experience, and a game.

4. The system of claim 2, where the instructions associated with the object are communicatively linked to a plurality of users simultaneously.

5. The system of claim 4, where the instructions associated with the object displays entertainment from multiple physical objects for a plurality of users simultaneously.

6. The system of claim 4, where the instructions associated with the object displays information from multiple physical objects for a plurality of users simultaneously.

7. The system of claim 4, where the instructions associated with the object provide interactivity between the plurality of users and the user wearing the object.

8. The system of claim 4, where the instructions associated with the object provide the plurality of users with a score for a competition.

9. The system of claim 4, where the instructions associated with the object provide the plurality of users with a goal.

10. The system of claim 4, where the instructions associated with the object provide the plurality of users with a task.

11. The system of claim 4, where the instructions associated with the object provide coordination between the plurality of users.

12. The system of claim 4, where the instructions associated with the object display costume and garb associated with a character represented by the physical object are overlaid on the player when viewed through the smart device to add realism.

13. The system of claim 4, where the instructions associated with the object adjust the user's outer appearance and capabilities automatically.

14. The system of claim 4, where the instructions associated with the object display information related to the physical object is overlaid on a user wearing the physical object viewed through the smart device.

15. A method for augmented realty, the method comprising the steps of:
a. locating a text, image or pattern using a smart device;
b. scanning the text, image or pattern using a camera embedded in the smart device;
c. retrieving and executing instructions executable on a processor from a storage to start enhanced augmented reality associated with the text, image or pattern; and
d. repeating steps a-c until a predefined goal has been reached by the user, the instructions executed by the processor associated with the object have completed, or both a predefined goal has been reached by the user and the instructions executed by the processor associated with the object have completed.

16. The method of claim 15, further comprising the step of uploading information to the smart device by a user.

17. The method of claim 15, further comprising the step of scanning the text, image or pattern and retrieving multimedia information related to the text, image or pattern that is displayed to the user.

18. The method of claim 15, further comprising the step of requesting additional actions by the user and stored in a storage.
